(19) United States
(12) Patent Application Publication
(10) Pub. No.: US 2013/0109427 A1
(43) Pub. Date: May 2, 2013

(54) Individual Security Through Mobile Device Notifications

(71) Applicant: George Matus, Salt Lake City, UT (US)

(72) Inventor: George Matus, Salt Lake City, UT (US)

(21) Appl. No.: 13/668,060

(22) Filed: Nov. 2, 2012

Related U.S. Application Data
(60) Provisional application No. 61/554,840, filed on Nov. 2, 2011.

(51) Int. Cl. H04H 20/59

(52) U.S. Cl. 455/521

(57) ABSTRACT

A method for providing individual security is disclosed. The method can be implemented at a mobile computing device that includes at least one processor. The method can include determining that a user at the mobile computing device may be under duress. The method can also include notifying one or more other mobile computing devices that are geographically proximate to the mobile computer device that the user at the mobile computing device may be under duress.

### RELATED APPLICATIONS

This application claims the benefit of U.S. Provisional Patent Application Ser. No. 61/554,840, entitled, “Individual Security Through Mobile Device Notifications,” filed on Nov. 2, 2011, which is incorporated in its entirety by reference and made a part hereof.

### BACKGROUND

1. The Field of the Invention

The present invention is generally related to embodiments to providing personal security through mobile device tracking and notifications.

2. The Relevant Technology

Mobile computing devices have become increasingly prevalent in contemporary living. Today, individuals carry with them a host of ever more powerful computing devices, such as cellular telephones, tablet computers, portable media players, and the like. Through these mobile devices, individuals are increasingly connected to those around them through electronic communications channels that are enabled by these devices.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an exemplary computing environment that facilitates providing individual security through mobile device notifications.

FIG. 2 illustrates an exemplary notification scenario in which, embodiments of the invention may be used.

### DETAILED DESCRIPTION

The present invention is generally directed to embodiments for providing individual (personal) security through mobile device notifications.

In some embodiments, a mobile computing device (e.g., cellular telephone, tablet computer, personal music player) detects that a protected person (e.g., a mobile device user or a person associated with the mobile device user) may be in duress (e.g., injured, kidnapped, under imminent threat, lost, etc.) and takes one or more protective actions. Protective actions may comprise sending one or more notifications, activating one or more audio or visual recording devices, tracking device location, sounding a local alarm, etc. As such, embodiments of the invention enable a person to use a mobile device to provide personal security for him or herself or for a closely associated person.

In some embodiments, the mobile computing device receives express user input indicating that a duress situation exists. Express user input may include activation of a software or hardware button (e.g., a “panic” or “help” button), receiving an audible voice command (e.g., a spoken word, such as “help,” “I'm lost,” “find my child,” “I'm being threatened,” “I'm hurt,” etc.), receiving a touch gesture at a touch-sensitive display, detecting a motion gesture (e.g., detecting that the mobile device is being shaken or moved in a pre-defined manner), receiving a particular key sequence (e.g. a particular sequence of volume button input), etc.

In additional or alternative embodiments, the mobile device infers that a duress situation exists. Inferring that a duress situation exists may include detecting that that a personal beacon is no longer in contact with the mobile device, detecting that the mobile device has deviated from a normal route or that the mobile device has crossed an expressly or impliedly defined perimeter, detecting a shock or impact of the mobile device, determining that a defined “check-in” period has elapsed without appropriate user input (i.e., a watchdog timer), etc.

In some embodiments, sending one or more notifications comprises sending one or more messages (e.g., SMS, MMS, e-mail, social networking) to a pre-defined contact list, either directly or through use of a notification service. As such, when the mobile device detects that the protected person may be in duress, the mobile device can automatically notify friends, co-workers, family, law enforcement personnel, etc. that the protected person is potentially in duress. Such notifications can include any information gathered by the mobile device that may be helpful for rendering assistance to the protected person.

In some embodiments, sending one or more notifications comprises “crowd-sourcing” assistance from others (even strangers) by sending one or more messages to one or more geographically proximate devices. For example, mobile device owners and/or mobile device manufacturers may configure mobile devices to receive crowd-sourced duress notifications. When a mobile device that implements embodiments of the present invention detects a duress situation, that mobile device can initiate a notification to other geographically proximate devices. As such, the mobile device and/or a separate notification service can determine one or more other devices that are within a local range of the mobile device and can initiate one or more notifications to each of these devices. Notice of the potential duress situation is therefore communicated to people who are likely able to react quickly to render assistance to the protected person.

In any case, notifications may include any information useful for locating and rendering assistance to the protected person. In some embodiments this information is provided in the notification(s) themselves, while in other embodiments the information is provided at a separate location (e.g., a web page). When information is available at a separate location, the notification(s) may provide notice that the protected person is potentially in duress, and also provide notice of the separate location where additional information may be found (e.g., a URL). Information useful for locating and rendering assistance may include image, video, or audio data captured by the mobile device; present or past geographical location information of the mobile device (e.g., a map showing a present and/or past location of the mobile device, past and/or present GPS coordinates, WiFi hotspot information, cellular tower information); a personal voice or text message provided by the protected person; a photograph of the protected person; personal information (e.g., blood type, prescription information, allergy information, insurance information, a physical description, automobile information); etc.

As indicated, one or more embodiments may include use of a personal beacon. In general, a personal beacon according to one or more embodiments of the invention comprises a device which maintains communication with the mobile device and which is worn by a protected person. For example, a personal beacon may comprise a wristband or other article of jewelry, a device embedded within an article of clothing (e.g., sewn into clothing, embedded within the sole of a shoe), an implanted device, etc. which is capable of communication with the mobile device. In some embodiments, the personal beacon comprises an electronic device that utilizes a wireless communication protocol (e.g., WiFi, BLUETOOTH, RFID, NFC, and the like). The personal beacon may be used to protect a person who may not be in possession of the mobile device, but who is generally near the mobile device (e.g., a child, an elderly person, a mentally-disabled person, etc.).

In some embodiments, the mobile device maintains some level of communication with the personal beacon (e.g., by receiving and/or exchanging “ping” messages from the personal beacon) and can determine when the personal beacon may no longer be within communicative range (e.g., when “ping” messages are no longer received). When the mobile device has lost contact with the personal beacon, the mobile device can initiate protective actions, such as an alarm, one or more notifications, etc. While the personal beacon may primarily include “pinging” functionality, in some embodiments the personal beacon include expansive functionality, such as a button (e.g., a “panic” or “help” button), an audio recording device, an image and/or video capture device, a geo-location device, etc.

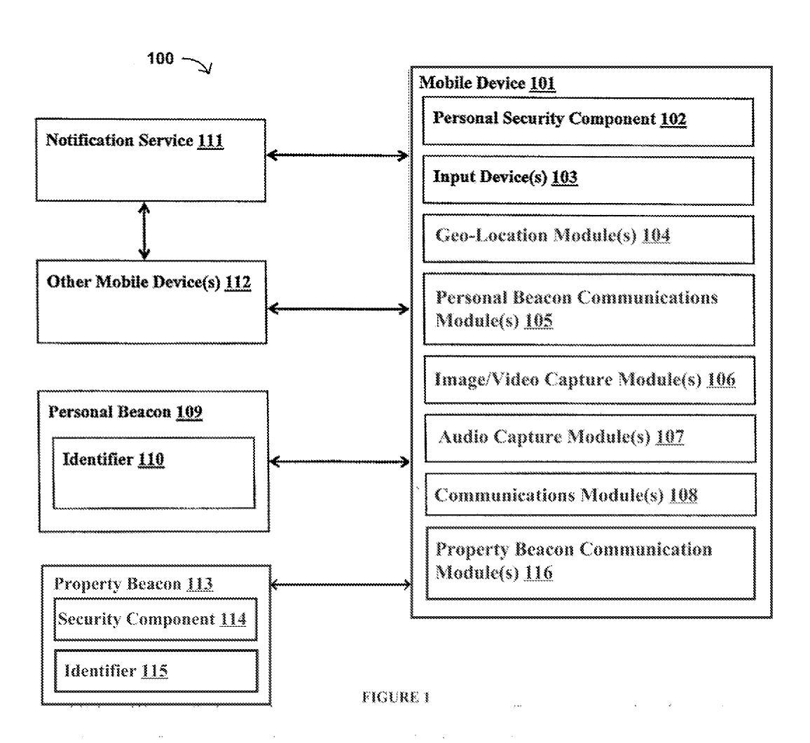

FIG. 1 illustrates an exemplary computing environment 100 that facilitates providing individual security through mobile device notifications. As shown, computing environment 100 includes mobile device 101, personal beacon 109, and notification or security service 111, which can each be connected via any appropriate communications means (e.g., WiFi, cellular communications, BLUETOOTH communications, etc.).

In general, mobile device 101 comprises a personal electronic device that is carried by a person. For example, mobile device 101 may comprise a cellular telephone, a portable media player, a tablet computer, etc. Mobile device 101 can include any appropriate electronic hardware, such as one or more processing units, one or more storage devices, etc.

As shown, mobile device 101 includes personal security component 102, which may comprise electronic hardware and/or software instructions. In general, personal security component 102 is configured to monitor mobile device 101 and/or personal beacon 109 for signs of duress. For example, personal security component 102 may monitor input device(s) 103 for signs of duress, including monitoring hardware and/or software buttons, monitoring touch screen input, and/or monitoring motion-sensing devices (e.g., compass, gyroscope, accelerometer, etc.). As such, personal security component 102 can detect express and inferred signs of duress, such as express user input, shock or impact of mobile device 101, motion gestures, etc.

In addition, personal security component 102 can monitor geo-location module(s) 104 (e.g., GPS, WiFi, Cellular Antenna) for a location of mobile device. As such, personal security component 102 can be configured to track the location of mobile device 101 over time, and to ascertain normal or common routes that mobile device 101 takes. When personal security component 102 determines that mobile device 101 has deviated from normal or common routes, or that mobile device 101 has left a defined perimeter (e.g., maximum distance from a home location, a maximum deviation from a learned or defined route, an expressly defined perimeter), personal security component 102 may infer that a protected person is under duress (e.g., being carried away by a kidnapper). In some embodiments, personal security component 102 can monitor device location and detect whether mobile device 101 is in the wrong location at the wrong time.

Further, personal security component 102 may use personal beacon communications module(s) 105 (e.g., a BLUETOOTH or RFID antenna) to determine whether personal beacon 109 is within communicative range of mobile device 101, or to determine a distance of personal beacon 109 from mobile device 101. When is it determined that personal beacon 109 has left communicative range, that personal beacon 109 has exceeded a defined distance from mobile device 101, or that personal beacon 109 indicates a duress situation exists (e.g., a button has been pressed on personal beacon 109), personal security component 102 may infer that a person possessing personal beacon 109 is under duress. Personal beacon 109 may contain a variety of hardware (e.g., buttons, recording devices, etc.) that is not depicted. As depicted, personal beacon 109 may include unique identifier 110, which may aid in locating a person possessing personal beacon 109, as discussed later.

Even further, personal security component 102 may use one or more of image/video capture module(s) 106 or audio capture module(s) 107 to monitor external surroundings. As such, one or more defined image/video or audio events may cause personal security component 102 to determine that a protected person is under duress. For example, personal security component 102 may use image/video and/or audio data to detect screaming, key words (e.g., “help,” “I'm lost,” “my child is missing,” “I'm hurt”), explosions, impacts, etc.

When it is determined that a protected person may be under duress, personal security component 102 can take a variety of actions. In some embodiments, personal security component uses communications module(s) 108 to send one or more messages (e.g., SMS, MMS, e-mail, social networking) to one or more defined lists of contacts. The defined list(s) of contacts may be stored a storage device at mobile device 101, or at a remote location. As indicated, the one or more messages and include any information appropriate to help locate and render assistance to the person possessing mobile device 101 (e.g., location, audio/video data, etc).

In other embodiments, personal security component 102 initiates one or more notices to other mobile devices that are geographically proximate to mobile device 101. For example, personal security component 102 may use communications module(s) 108 to contact notification service 111, which in turn sends notice to one or more other mobile device(s) 112 known by notification service 111 to be near mobile device 101. The notice can inform those devices of the potential duress situation with respect to mobile device 101. In general, notice may be sent to proximate devices even when the owners of those devices may not have a pre-existing relationship with the owner of mobile device 101 (i.e., strangers). In some embodiments, personal security component 102 may send notices to geographically proximate mobile devices directly without use of notification service 111. As such, some embodiments of the invention may include use of notification service 111, while other embodiments may omit notification service 111 completely.

In addition to sending notice to other mobile device(s) 112, notification service 111 may take part in any part of the actions performed by personal security component 102. For example, notification service 111 may provide offline processing services or may send SMS, MMS, social networking, etc. messages on behalf of mobile device 101. Notification service 111 may also host information relevant to notifications, such as personal information (e.g., allergy information, prescription information, etc.).

Personal security component 102 may also initiate recoding of audio and/or visual information, gathering of geo-location information, etc. which may assist others to aid the protected person or which may help law enforcement officials.

In another embodiment, the computing environment 100 can include a property beacon 113 that can communicate (e.g., via a BLUETOOTH or RFID antenna) with property beacon communications module(s) 116 (e.g., a BLUETOOTH or RFID antenna) of mobile device 101. As shown, the property beacon 113 includes security component 114, which may comprise electronic hardware and/or software instructions. In general, security component 114 is configured to monitor property beacon 113 for signs of duress. For example, security component 114 may monitor a motion-sensing device (e.g., compass, gyroscope, accelerometer, etc.) for signs of duress. As such, security component 114 can detect inferred signs of duress, such as shock, impact, etc. of property beacon 113. Property beacon 113 may contain a variety of hardware (e.g., buttons, recording devices, etc.) that is not depicted. As depicted, property beacon 113 may include unique identifier 115, which may aid in locating a property beacon 113. The property beacon 113 can be applied to or associated with a home (e.g., a window, door, etc.), a bicycle, a car, a computer, or any other kind of personal property. The property beacon 113 can communicate to the mobile device 101 when a window is broken or open, a bicycle or car is stolen, etc. The personal security component 102 can then initiate one or more notices to other mobile devices 112 and/or notification service 111, as described herein. The property beacon 113 can therefore be used to protect homes from intrusion and personal property, such as cars or computers, from theft. Thus, personal property and homes, as well as individuals, can be protected and monitored by the technology of the present disclosure.

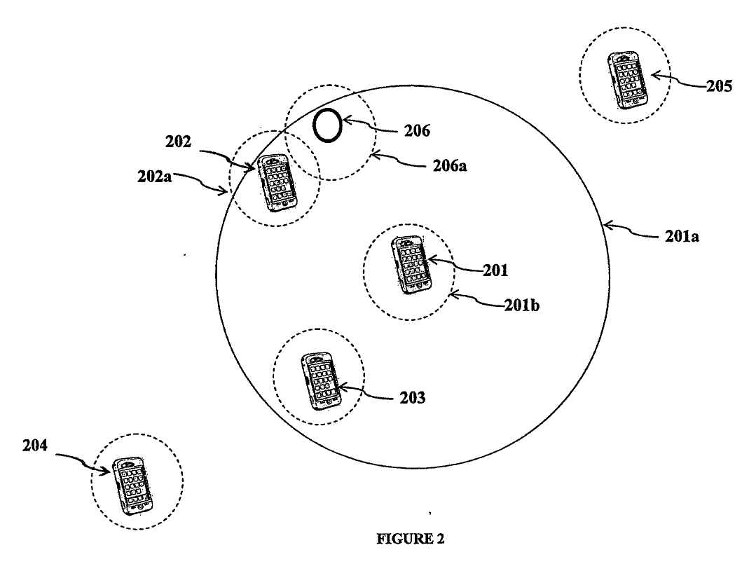

FIG. 2 illustrates an exemplary notification scenario in which computing environment 100 may be used. As depicted, a notification scenario may include a plurality of mobile devices, such as mobile devices 201, 202, 203, 204, and 205. Some mobile devices may be relatively geographically proximate to one another, and some mobile devices may be relatively geographically distant. For example, mobile devices 202 and 203 may be considered geographically proximate to mobile device 201, while mobile devices 204 and 205 may be considered geographically distant from mobile device 201, as indicated by perimeter 201a surrounding mobile device 201. The particular boundaries of perimeter 201a may be an expressly-defined distance or may be based on dynamic factors (e.g., the density of mobile devices, crime rates in the area, etc.).

When a duress situation is detected at mobile device 201, mobile device 201 may initiate one or more notifications over electronic communication channels (e.g., SMS, MMS, social networking). Additionally or alternatively, mobile device 201 may initiate a localized notification (e.g., a “push” notification) to proximate mobile devices 202 and 203. These “push” notifications may contain information relevant to rendering assistance to a person at mobile device 201 (e.g., a photograph, a location, etc.). In addition, mobile device 201 may sound an alarm to warn off an attacker and/or to attract others to the location of mobile device 201.

In addition, a notification scenario may include one or more personal beacons, such as personal beacon 206 (e.g., a wrist band). As depicted, each mobile device and personal beacon 206 may have an operable communications range (e.g., a BLUETOOTH or RFID range). For example, mobile device 201 may have range 201b, mobile device 202 may have range 202a, and personal beacon 206 may have range 206a. As such, mobile devices can detect when personal beacon 206 has left communicative range, or when personal beacon 206 has entered communicative range.

In the depicted example, personal beacon 206 has left communicative range of mobile device 201. This may happen because a child wearing personal beacon 206 has wandered away from a parent possessing mobile device 201, or because the child has been kidnapped and is being carried away. Mobile device 201 may responsively initiate notification to pre-defined contact list(s) through electronic channels (e.g., SMS, MMS, social networking), and may initiate “push” notifications to local mobile device 202 and 203 (i.e., a local “Amber” alert). As such, users at mobile devices 202 and 203 may be on the lookout for the child, and may have received a name, a photograph, a physical description, etc. As depicted, personal beacon 206 has entered communicative range 202a of mobile device 202. Mobile device 202 may therefore detect an identifier (e.g., identifier 110 of FIG. 1) of personal beacon 206, and may notify its user that the child is nearby. Mobile device 202 may also notify (e.g., via an SMS message) mobile device 201 (or any other party, such as law enforcement officials) that personal beacon 206 has been detected, either automatically or through user interaction. After finding the child, a user at mobile device 202 may respond to the “push” notification to let the user at mobile device 201 know that the child has been found.

In some embodiments, other devices which did not receive a “push” notice may detect a personal beacon. For example remote device 205 is outside of perimeter 201a and may not have received a “push” notification when personal beacon 206 lost contact. However, if personal beacon 206 enters range of remote device 205, then that remote device 205 may receive notice that beacon 206 is in range, and/or may receive any appropriate notice to inform a user at device 205 of the status of personal beacon 206 (e.g., notice that a child has been reported missing, a picture of the child, etc.). As such, computing environment 100 can enable rendering of assistance to carriers of personal beacons over broad geographical areas.

The foregoing presents only a few examples of use of computing environment 100. Computing environment 100 may be used in a many additional scenarios.

As indicated, for example a user of a mobile device may define an allowed perimeter for a personal beacon (e.g., 10 feet, 20 feet, 20 meters, etc.), as opposed to relying only a wireless communications range of the personal beacon. In addition, a single remote device may be able to track a plurality of personal beacons (e.g., beacons carried by two or more children).

Furthermore, the manner in which notifications are sent may be automated and/or involve additional user input. For example, if a personal beacon has left communications range or a defined perimeter, the associated mobile device may alert its user that the beacon has exceeded its boundary. The alert may be accompanied with an audible alarm. Then, the user may decide that additional notification needs to be sent, and initiate a “push” notice to local devices and/or electronic communication with a list of contacts. As such, the sending of messages need not be automatic, but may in fact involve express user input.

In some embodiments, notifications are sent automatically when a protected person does not respond to a prompt, and/or may be sent to more parties as time elapses. For example, in embodiments when a remote device learns a protected person's typical travel patterns and sends notices when that protected person deviates from those patterns or crosses beyond a perimeter, the mobile device may prompt the protected person (perhaps in a cryptic manner) as to whether the movement is intentional. If the protected person does not respond within a defined interval (e.g., three minutes) then the mobile device may send a first set of notifications (e.g., notify a first contact list via SMS). Then, if the mobile device remains outside of the perimeter or has not received an affirmative response from the protected person, the mobile device may send a second set of notifications (e.g., notify a second contact list via local “push” notification and email) after another defined interval (e.g., ten minutes).

In some embodiments, a protected person may initiate a pre-warn notification. For example, a protected person may provide input indicating that the protected person will be leaving a party at a specified time and will be taking the subway. The protected person can then follow-up with input indicating that the protected person has arrived home safely. The mobile device may send messages to a contact list at any time during the process. For example, if a defined time interval elapses without the mobile device detecting that the protected person has arrived home (e.g., via express input or via detecting a home location via GPS), then the mobile device may inform a contact list that the protected person left the party and took the subway, and that the protected person has not reported home. In some embodiments, contacts may be notified as soon as the protected person indicated that he or she left the party.

In some embodiments, mobile devices may record information (e.g., audio and video) after detecting a duress situation to help law enforcement investigate the situation. The recorded information may be stored locally at the mobile device, or may be uploaded to a remote computer.

In some embodiments, other remote devices may be enabled to connect (e.g., via WiFi, BLUETOOTH, Cellular communications, etc.) to a mobile device that is reporting its protected person is under duress to gather audio and/or video information. As such, the device reporting duress may record audio and/or video of its surroundings and transmit this data (either directly or indirectly) to other devices (locally proximate or otherwise) so that the users of those devices can hear and/or see what is happening to the protected person in real-time or near real-time.

In some embodiments, any sound being recorded or played at a mobile device can be “pushed” to other mobile devices. For example, if a mobile device is sounding an alarm because its user is under duress, that sound can be transmitted to other local remote devices. As such, each local mobile device can act as an additional speaker for the alarm. In some embodiments, the volume of the sound may be different for each mobile device. For example, mobile devices that are near the mobile device sounding the alarm may play the alarm more loudly than mobile devices that are farther from the mobile device sounding the alarm. As such, the alarm can sound loudest at the mobile device initiating the alarm and taper off as the distance from the mobile device sounding the alarm increases.

The foregoing embodiments of broadcasting sounds can apply beyond alarms. For example, a user may play a song at his mobile device, and broadcast that song to geographically proximate mobile devices. For example, George (a primary/DJ), who is at a beach party, may select and start playing a song (e.g., “Surfin' USA” by the Beach Boys) from a music library on his mobile device. Matt, who is next to George on the beach may select ‘Join’ or ‘Sync’ with DJ on his own mobile device. As a result, Matt's mobile device would start playing “Surfin' USA,” synchronized with George's song in real-time. Matt's mobile device may play the song from a file stored locally at Matt's device, or may play the song from a streaming audio connection with George's mobile device. Several members of George's family may also select ‘Join’ or ‘Sync’ from their own mobile devices device, resulting in a beach party in “surround sound.” The more friends, the louder the song. In the case of music, users may have the ability to ‘like’ or ‘dislike’ a song, and the “DJ” mobile device may implement ‘what's hot or not’ functionality (i.e., a list of the top songs everyone is listening to).

Embodiments of the invention also include the “crowd-sourced” reporting of crimes (i.e., crime-sourcing). For example, users may use mobile devices to report the occurrence of crimes, including the nature and location of the crime. Local mobile devices may be notified of the crime (either as a warning to stay away or as a request for help), and law enforcement can be notified of the crime. Data reported by multiple mobile devices can be aggregated and used to map and track crime patterns. For example, when a user reports a crime, a “pin” may be added to a map, identifying the location of the crime. Then, users can see where crimes are likely to be committed. If a user is going on vacation to New York City, for example, the user may access the crime-sourcing map and see that there are thousands of pins in a few blocks in Harlem and no pins or very few pins in mid-town.

Along these same lines, embodiments of the invention may also predict the likelihood of a crime taking place in a specific “location” at a specific “time” on a percentage or other measuring basis. For example, based on the reported crime information, a computer system may estimate that a crime at a particular location happens at a particular frequency. Thus, the computer system may predict a percentage chance of a crime happening at a given time within that location. For example, if a crime happens every three weeks on average over a period of time at a specific location, the day after the crime there is a 1% chance of another crime happening, one week after the crime there is a 10% chance, three weeks after the crime there is a 50% percent chance, and so on. This information can be displayed on a map as well (e.g., using a color scheme).

In some embodiments, crimes may be reported through navigation of a user interface (e.g., a user expressly placing a pin on a map, a user pressing a button which initiates the reporting of a crime, etc). In other embodiments, crimes by be reported through voice commands (e.g., “a woman was just robbed at my location,” “there is a fight at the football stadium,” “the convenience store on the corner of State and Main was just robbed,” etc.). In either case, the mobile device can detect its present location to provide context for the crime report.

In addition, embodiments may include facial recognition functionality. As such, a user may use an image capture device to take a picture of a subject. Using a local or remote database, the mobile device may identify the subject from the picture using facial recognition technology. Then, using a local or remote database, the mobile device may perform a background check on the subject and present background information to the user (e.g., whether or not the individual has a criminal record, is a registered pedophile, sex abuser, etc.).

The foregoing is not an exhaustive list of protection scenarios or use cases. Other protection scenarios or use cases are enabled by embodiments of the present invention.

Embodiments of the present invention may comprise or utilize special purpose or general-purpose computing devices that include computer hardware, such as, for example, one or more processors and system memory, as discussed in greater detail below. Embodiments within the scope of the present invention also include physical and other computer-readable and recordable type media for storing computer-executable instructions and/or data structures. Such computer-readable recordable media can be any available media that can be accessed by a general purpose or special purpose computer system. Computer-readable media that store computer-executable instructions according to the invention are recordable-type storage media or other physical computer storage media (devices) that are distinguished from merely transitory carrier waves.

Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CDROM, DVD-ROM, HD-DVD, BLU-RAY or other optical disk storage, magnetic disk storage or other magnetic storage devices, or any other medium which can be used to store desired program code means in the form of computer-executable instructions or data structures and which can be accessed by a general purpose or special purpose computer and which are recorded on one or more recordable type medium (device).

A “network” is defined as one or more data links or communication channels that enable the transport of electronic data between computer systems and/or modules and/or other electronic devices. When information is transferred or provided over a network or another communications connection or channel (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at one or more processor, cause one or more general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described herein. Rather, the described features and acts are disclosed as example forms of implementing the claims.

Those skilled in the art will appreciate that the invention may be practiced in network computing environments with many types of computer system configurations, including, personal computers, desktop computers, laptop/notebook computers, message processors, hand-held devices, multi-processor systems, microprocessor-based or programmable consumer electronics, network PCs, minicomputers, mainframe computers, tablets, mobile telephones, PDAs, pagers, routers, switches, and the like. The invention may also be practiced in distributed and cloud system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

It should be understood that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, implemented at a mobile computing device that includes at least one processor, for providing individual security, the method comprising:
associating with a personal beacon and maintaining communications with the personal beacon;
detecting that the personal beacon in no longer within range of the mobile computing device, or has left a defined perimeter from the mobile computing device; and
notifying one or more other mobile computing devices that are geographically proximate to the mobile computer device that a person associated with the personal beacon may be in duress.

2. A method, implemented at a mobile computing device that includes at least one processor, for providing individual security, the method comprising:
determining that a user at the mobile computing device may be under duress; and
notifying one or more other mobile computing devices that are geographically proximate to the mobile computer device that the user at the mobile computing device may be under duress.

3. A method, implemented at a mobile computing device that includes at least one processor, for providing individual security, the method comprising:
monitoring geographical movement of the mobile computing device;
developing a geographical movement profile representing normal geographical locations for the mobile computing device;
determining that the mobile computing device has deviated from the normal geographical locations; and
sending one or more notifications to a pre-defined contact list informing each contact that the mobile computing device has deviated from the normal geographical locations.

4. A computer-implemented method for providing crowd-sourced crime information, the method comprising:
receiving a plurality of notifications from a plurality of mobile computing devices, each notification indicating that a crime has occurred at a particular geographical location corresponding to a geographical location of one of the plurality of mobile computing devices;
aggregating the plurality of notifications into a crime map, including annotating the crime map with information indicating where each crime has occurred for each of the plurality of notifications; and
providing at least a portion of the crime map to at least one mobile computing device.

5. A computer-implemented method for providing crowd-sourced crime information, the method comprising:
processing a crime map, the crime map containing information about a plurality of crimes that have been reported, for each crime the information including a particular geographical location where the crime was reported to have occurred and a particular time at which the crime was reported;
processing the crime map to compute a probability of a crime happening at least one geographical location and at a particular time, including processing a number and frequency of past crimes that have been reported at the at least one geographical location; and
sending the computed probability of a crime happening at the least one geographical location and at the particular time to at least one mobile computing device.
